(19) United States
(12) Patent Application Publication
(10) Pub. No.: US 2025/0060831 A1
(43) Pub. Date: Feb. 20, 2025

(54) SYSTEMS AND METHODS FOR GESTURE-BASED CONTROL OF VIRTUAL TRY-ON EXPERIENCE

(71) Applicant: Perfect Mobile Corp., New Taipei City (TW)

(72) Inventors: Chieh-Chung WU, New Taipei City (TW); Fan KAO, Taipei City (TW); Hsiu-Jui CHANG, New Taipei City (TW)

(21) Appl. No.: 18/799,702

(22) Filed: Aug. 9, 2024

Related U.S. Application Data
(60) Provisional application No. 63/519,883, filed on Aug. 16, 2023.

(51) Int. Cl. G06F 3/01; G06V 40/10; G06V 40/20

(52) U.S. Cl. CPC G06F 3/017; G06F 3/011; G06V 40/10; G06V 40/28

(57) ABSTRACT

A computing device obtains an image depicting a hand of a user and superposes a default wrist accessory on the hand of the user. The image is displayed with the default wrist accessory on the hand of the user. The computing device detects at least one finger on the hand of the user with the default wrist accessory and determines whether the at least one finger exhibits one of a plurality of pre-defined target finger features. A new wrist accessory is selected based on the at least one finger exhibiting one of the pre-defined target finger features. A virtual representation of a new wrist accessory is displayed.

### CROSS-REFERENCE TO RELATED APPLICATION

This application claims priority to, and the benefit of, U.S. Provisional Patent Application entitled, “Number Gestures as Pattern Control in Virtual Hand Try-on,” having Ser. No. 63/519,883, filed on Aug. 16, 2023, which is incorporated by reference in its entirety.

### TECHNICAL FIELD

The present disclosure generally relates to incorporating gesture-based control for an interactive augmented reality experience during a virtual try-on session.

### SUMMARY

In accordance with one embodiment, a computing device obtains an image depicting a hand of a user and superposes a default wrist accessory on the hand of the user. The computing device displays the image with the default wrist accessory on the hand of the user. The computing device detects at least one finger on the hand of the user with the default wrist accessory and determines whether the at least one finger exhibits one of a plurality of pre-defined target finger features. The computing device selects a new wrist accessory based on the at least one finger exhibiting one of the pre-defined target finger features. The computing device displays a virtual representation of a new wrist accessory.

Another embodiment is a system that comprises a memory storing instructions and a processor coupled to the memory. The processor is configured by the instructions to obtain an image depicting a hand of a user and superpose a default wrist accessory on the hand of the user. The processor is further configured to display the image with the default wrist accessory on the hand of the user. The processor is further configured to detect at least one finger on the hand of the user with the default wrist accessory and determine whether the at least one finger exhibits one of a plurality of pre-defined target finger features. The processor is further configured to select a new wrist accessory based on the at least one finger exhibiting one of the pre-defined target finger features. The processor is further configured to display a virtual representation of a new wrist accessory.

Another embodiment is a non-transitory computer-readable storage medium storing instructions to be implemented by a computing device. The computing device comprises a processor, wherein the instructions, when executed by the processor, cause the computing device to obtain an image depicting a hand of a user and superpose a default wrist accessory on the hand of the user. The processor is further configured by the instructions to display the image with the default wrist accessory on the hand of the user. The processor is further configured by the instructions to detect at least one finger on the hand of the user with the default wrist accessory and determine whether the at least one finger exhibits one of a plurality of pre-defined target finger features. The processor is further configured by the instructions to select a new wrist accessory based on the at least one finger exhibiting one of the pre-defined target finger features. The processor is further configured by the instructions to display a virtual representation of a new wrist accessory.

Other systems, methods, features, and advantages of the present disclosure will be apparent to one skilled in the art upon examining the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure are better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device configured to provide gesture-based control of a virtual try-on session according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for providing gesture-based control of a virtual try-on session according to various embodiments of the present disclosure.

FIG. 4 illustrates an example user interface provided on a display of the computing device according to various embodiments of the present disclosure.

FIG. 5 illustrates an example of the computing device of FIG. 1 displaying a virtual representation of a new wrist accessory based on a gesture performed by the user of the computing device according to various embodiments of the present disclosure.

FIG. 6 illustrates another example of the computing device of FIG. 1 displaying a virtual representation of a new wrist accessory based on a gesture performed by the user of the computing device according to various embodiments of the present disclosure.

FIG. 7 illustrates an example user interface displayed on the computing device of FIG. 1, where the user interface includes a wrist accessory toolbar to facilitate the selection of one or more wrist accessories of interest according to various embodiments of the present disclosure.

FIG. 8 illustrates another example user interface displayed on the computing device 102 of FIG. 1, where the user interface includes a wrist accessory toolbar to facilitate the selection of one or more wrist accessories of interest according to various embodiments of the present disclosure.

### DETAILED DESCRIPTION

The subject disclosure is now described with reference to the drawings, where like reference numerals are used to refer to like elements throughout the following description. Other aspects, advantages, and novel features of the disclosed subject matter will become apparent from the following detailed description and corresponding drawings.

Embodiments are disclosed for implementing gesture-based control of a virtual try-on session, thereby allowing users to hold a computing device in one hand while using the other hand to navigate a user interface for purposes of evaluating different wrist accessories worn on that hand. A description of a system for gesture-based control of a virtual try-on session for wrist accessories is described followed by a discussion of the operation of the components within the system.

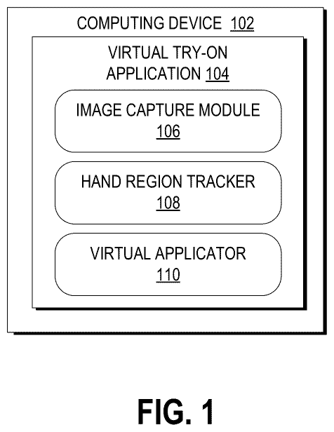

FIG. 1 is a block diagram of a computing device 102 in which the embodiments disclosed herein may be implemented. The computing device 102 may comprise one or more processors that execute machine executable instructions to perform the features described herein. For example, the computing device 102 may be embodied as a computing device such as, but not limited to, a smartphone, a tablet-computing device, a laptop, and so on.

A virtual try-on application 104 executes on a processor of the computing device 102 and includes an image capture module 106, a hand region tracker 108, and a virtual applicator 110. The image capture module 106 is configured to obtain digital images of a user's hand and display the user's hand on a display of the computing device 102 for purposes of evaluating wrist accessories of interest.

The images obtained by the image capture module 106 may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats. The video may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

The hand region tracker 108 is executed by the processor of the computing device 102 to display a virtual representation of a default wrist accessory on the wrist of the hand of the user and to detect a gesture performed by the hand with the virtual representation of the default wrist accessory for purposes of evaluating other wrist accessories of interest. The hand region tracker 108 is further executed by the processor of the computing device 102 to determine whether the gesture matches one of a grouping of pre-defined target gestures. Based on whether a match is identified by the hand region tracker 108, the virtual applicator 110 is executed to display a virtual representation of a new wrist accessory on the wrist of the user's hand.

For some embodiments, the hand region tracker 108 is configured to superpose a default wrist accessory on the hand of the user and display the image with the default wrist accessory on the hand of the user. The hand region tracker 108 is further configured to detect one or more fingers on the hand of the user with the default wrist accessory and determine whether the detected finger(s) exhibits one of a grouping of pre-defined target finger features. For example, the hand region tracker 108 may be configured to whether the user raises a target number of fingers on the hand with the default wrist accessory, whether the user forms a fist, whether the user shows the front (or back) of the hand of the user, and so on. The hand region tracker 108 selects a new wrist accessory based on the one or more fingers exhibiting one of the pre-defined target finger features.

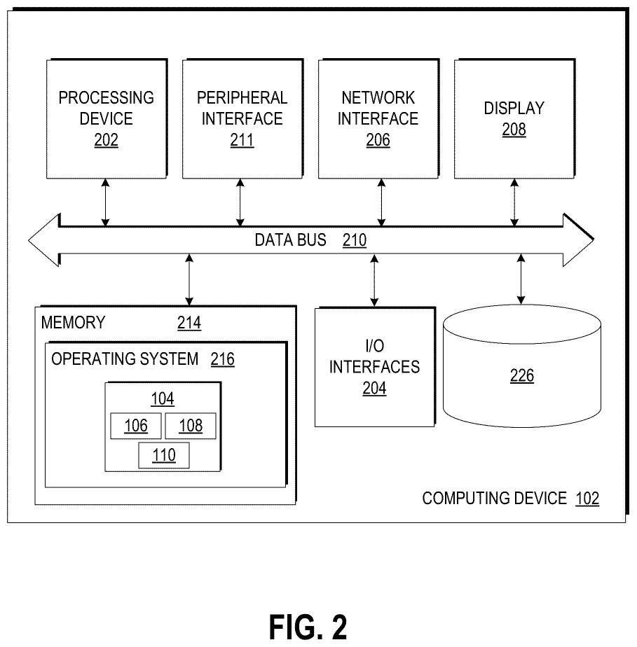

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM) such as DRAM and SRAM) and nonvolatile memory elements (e.g., ROM, hard drive, tape, CDROM). The memory 214 typically comprises a native operating system 216, one or more native applications, emulation systems, or emulated applications for any of a variety of operating systems and/or emulated hardware platforms, emulated operating systems, etc. For example, the applications may include application specific software that may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

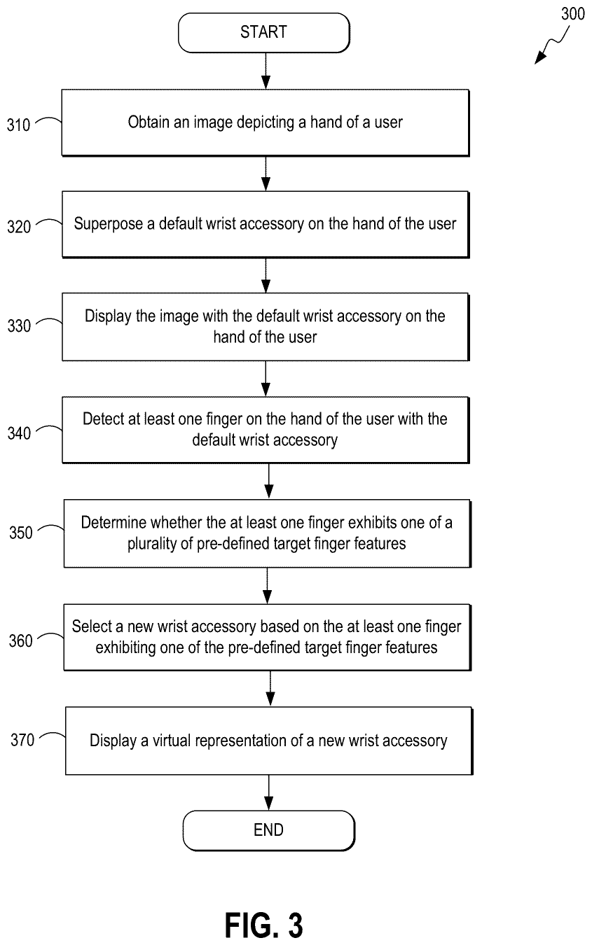

Reference is made to FIG. 3, which is a flowchart 300 in accordance with various embodiments for providing gesture-based control of a virtual try-on session, where the operations are performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. In addition, two or more blocks shown in succession in FIG. 3 may be executed concurrently or with partial concurrence. It is understood that all such variations are within the scope of the present disclosure.

At block 310, the computing device 102 obtains an image depicting a hand of a user. At block 320, the computing device 102 superposes a default wrist accessory on the hand of the user. The default wrist accessory may comprise, for example, a default watch design, a default bracelet design, a default tattoo design, a default wrist brace design, and so on.

At block 330, the computing device 102 displays the image with the default wrist accessory on the hand of the user. At block 340, the computing device 102 detects at least one finger on the hand of the user with the default wrist accessory. For embodiments, the computing device 102 utilizes an artificial intelligence model to detect and analyze the gestures performed by the user.

At block 350, the computing device 102 determines whether the at least one finger exhibits one of a plurality of pre-defined target finger features. For some embodiments, the computing device 102 monitors for a number of fingers on the hand of the user with the default wrist accessory, a fist formed by the hand of the user, a front of the hand of the user, a back of the hand of the user, and so on to determine whether a pre-defined target finger feature is performed by the user. For some embodiments, the computing device 102 detects feature points of fingers of the hand and determines whether a number of detected feature points of the hand matches a threshold number of feature points defined in the plurality of pre-defined target finger features.

At block 360, the computing device 102 selects a new wrist accessory based on the at least one finger exhibiting one of the pre-defined target finger features. For some embodiments, the computing device 102 selects the new wrist accessory by selecting a new color or a new texture for the default wrist accessory. For some embodiments, the computing device 102 selects the new wrist accessory based on which pre-defined target finger feature is exhibited by the at least one finger on the hand with the default wrist accessory.

At block 370, the computing device 102 displays a virtual representation of a new wrist accessory. For some embodiments, the computing device 102 displays the virtual representation of the new wrist accessory on the hand when the computing device 102 detects any of the pre-defined target finger features, otherwise, the virtual representation of the new wrist accessory is not displayed on the hand when the computing device 102 does not detect any of the pre-defined target finger features. The wrist accessory does not change on the hand when the computing device 102 does not detect any of the pre-defined target finger features. Thereafter, the process in FIG. 3 ends.

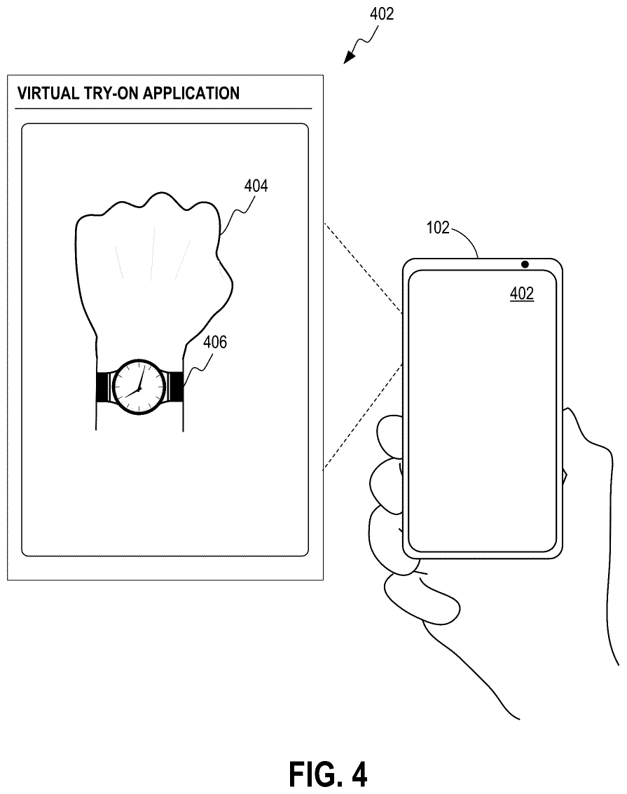

To illustrate various aspects of the present invention described above, reference is made to the following figures. FIG. 4 illustrates an example user interface 402 provided on a display of the computing device 102 whereby an image of the user's hand 404 is captured and displayed to the user. For some implementations, the image capture module 106 (FIG. 1) executing in the computing device 102 is configured to cause a camera of the computing device 102 to capture an image or a video of the user's hand 404 for purposes of performing virtual try-on of wrist accessories of interest. Such wrist accessories may include, for example, watches, bracelets, and so on.

In the example shown in FIG. 4, the user is holding the computing device 102 with one hand while using the computing device 102 to capture an image of the user's other hand 404, which is displayed in the user interface 402. Advantageously, the user is able to use the same hand to evaluate wrist accessories of interest and to navigate the user interface 402. Also shown is a wrist accessory 406 displayed on the user's hand 404 in the context of an augmented reality (AR) session executed by the computing device 102. The hand region tracker 108 (FIG. 1) executing in the computing device 102 monitors for the presence of the user's hand in the field of view of the camera of the computing device 102. Upon detecting the presence of the user's hand, the hand region tracker 108 identifies feature points of the hand region for purposes of determining whether the user's hand 404 is performing a gesture.

The hand region tracker 108 determines whether any gestures performed by the user's hand 404 matches any of a grouping of pre-defined target gestures. Such pre-defined target gestures may comprise, for example, the user raising one or more fingers, the user's hand's transitioning to or toggling back and forth between an open hand and a clinched fist, a waving gesture, and so on. If the hand region tracker 108 determines that the current gesture performed by the user's hand does not match any of the pre-defined target gestures, the virtual applicator 110 (FIG. 1) executing in the computing device 102 displays a default wrist accessory on the user's hand. In the example shown in FIG. 4, assume that the user's current gesture (clinched fist) does not match any of the pre-defined target gestures. In this example, the virtual applicator 110 displays a default wrist accessory 406 comprising a default watch design. The default wrist accessory 406 may be set by the virtual try-on application and/or specified by the user of the computing device 102.

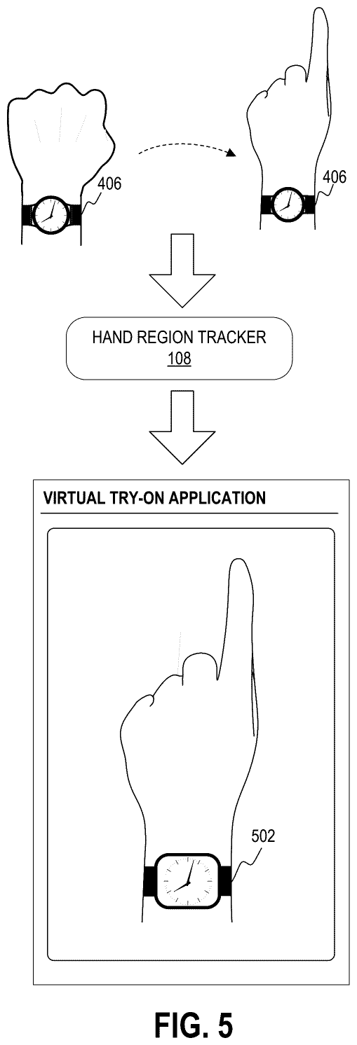

FIG. 5 illustrates an example of the computing device 102 of FIG. 1 displaying a virtual representation of a new wrist accessory based on a gesture performed by the user of the computing device 102. In the example shown, the user transitions from a clinched fist to raising a single finger. Assume for purposes of illustration that this gesture (i.e., raising of a single finger) matches one of the pre-defined target gestures. The hand region tracker 108 (FIG. 1) executing in the computing device 102 detects a match, and the virtual applicator 110 (FIG. 1) switches from the previous wrist accessory 406 shown in FIG. 4 to a new wrist accessory 502 and displays a virtual representation of the new wrist accessory 502 on the wrist of the user's hand. In the example shown in FIG. 5, the new wrist accessory 502 comprises a different watch design. However, the new wrist accessory 502 may comprise a different bracelet, a different wristband, and so on.

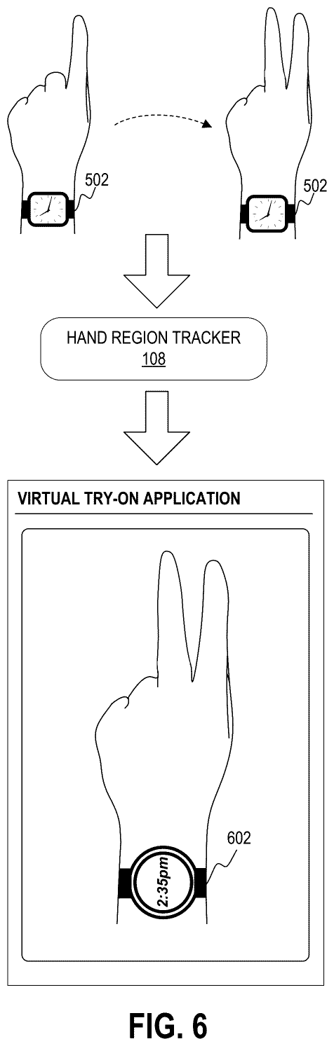

FIG. 6 illustrates another example of the computing device 102 of FIG. 1 displaying a virtual representation of a new wrist accessory based on a gesture performed by the user of the computing device 102. In the example shown, the user has evaluated the wrist accessory 502 from FIG. 5 and wishes to try on yet another wrist accessory. To achieve this, the user performs a different gesture. In this example, the user raises two fingers. Assume for purposes of illustration that this gesture (i.e., raising of two fingers) matches another one of the pre-defined target gestures. The hand region tracker 108 (FIG. 1) executing in the computing device 102 detects a match, and the virtual applicator 110 (FIG. 1) switches from the previous wrist accessory 502 to a new wrist accessory 602 and displays a virtual representation of the new wrist accessory 602 on the wrist of the user's hand.

In the example shown in FIG. 6, the new wrist accessory 602 comprises yet another watch design. However, the new wrist accessory 602 may also comprise the previous wrist accessory design but in a different color, a different texture, and so on. Note that each of the pre-defined gestures has an associated operation for navigating the user interface shown on the computing device 102. In some implementations, each of the pre-defined target gestures corresponds to a different number of fingers, where the number of fingers may correspond directly to a particular wrist accessory. For example, raising four fingers may correspond to the fourth wrist accessory. To specify a higher selection (e.g., the seventh wrist accessory), the user simply performs two gestures in quick succession (e.g., open hand gesture followed by a gesture where only two fingers are raised). Based on whether the two gestures occur within a pre-defined time threshold (e.g., less than two seconds), the virtual applicator 110 (FIG. 1) interprets the succession of gestures as either a single wrist accessory selection or as separate wrist accessory selections.

In other implementations, however, each of the pre-defined target gestures may correspond to a particular operation for navigating the user interface. For example, one pre-defined target gesture may comprise holding up one finger where this corresponds to moving forward to the next available wrist accessory. As another example, another pre-defined target gesture may comprise holding up two fingers where this corresponds to moving back to the previous available wrist accessory.

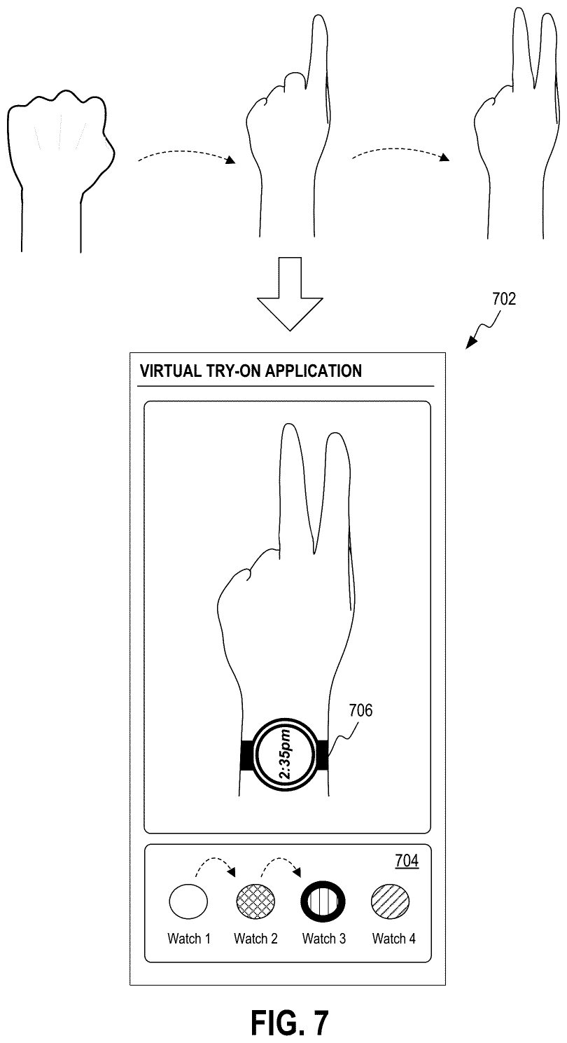

FIG. 7 illustrates an example user interface displayed on the computing device 102 of FIG. 1, where the user interface 702 includes a wrist accessory toolbar 704 to facilitate the selection of one or more wrist accessories of interest. In the example shown, the user interface 702 includes a wrist accessory toolbar 704 that comprises thumbnails of different wrist accessory designs. The order in which the wrist accessory designs are arranged in the toolbar 704 aids the user in determining which gesture to perform for purposes of navigating the toolbar 704 and selecting the wrist accessory of interest.

In the example show, the user transitions from a clinched fist to holding up one finger and then to holding up two fingers. Assume for this example that these gestures are interpreted by the virtual applicator 110 (FIG. 1) as separate gestures corresponding to respective wrist accessory selections. These gestures cause the virtual applicator 110 to select different wrist accessories 706 to display on the wrist of the user's hand. As discussed earlier, in some implementations, each of the pre-defined target gestures may correspond to a different number of fingers, where the number of fingers may correspond directly to a particular wrist accessory. For example, raising two fingers may correspond to the second wrist accessory shown in the wrist accessory toolbar 704.

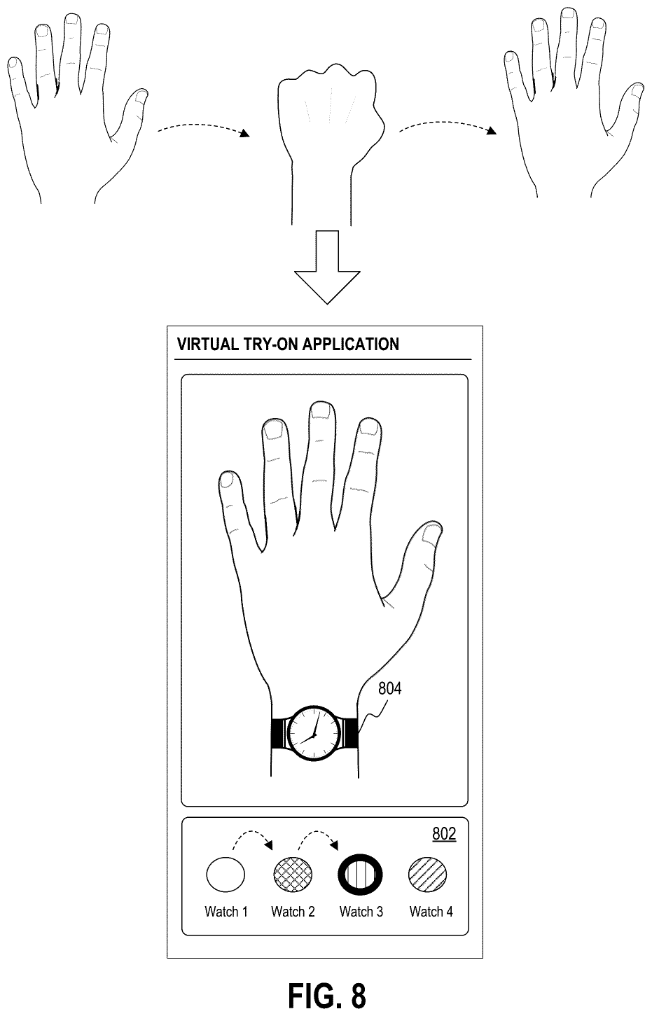

In other implementations, however, each of the pre-defined target gestures may correspond to a particular operation for navigating the user interface. To illustrate, reference is made to FIG. 8, which depicts another example user interface displayed on the computing device 102 of FIG. 1, where the user interface similarly includes a wrist accessory toolbar 802 to facilitate the selection of one or more wrist accessories of interest. In the example shown, transitioning back forth between an open hand and a clinched fist may correspond to moving forward to the next available wrist accessory. This series of gestures triggers the virtual applicator 110 executing in the computing device 102 to select a new wrist accessory 804 to display on the wrist of the user.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are included herein within the scope of this disclosure and protected by the following claims.

At least the following is claimed:

1. A method implemented in a computing device, comprising:
obtaining an image depicting a hand of a user;
superposing a default wrist accessory on the hand of the user;
displaying the image with the default wrist accessory on the hand of the user;
detecting at least one finger on the hand of the user with the default wrist accessory;
determining whether the at least one finger exhibits one of a plurality of pre-defined target finger features;
selecting a new wrist accessory based on the at least one finger exhibiting one of the pre-defined target finger features; and
displaying a virtual representation of a new wrist accessory.

2. The method of claim 1, wherein detecting the at least one finger comprises detecting one or more of: a number of fingers on the hand of the user with the default wrist accessory, a fist formed by the hand of the user, a front of the hand of the user, and a back of the hand of the user.

3. The method of claim 1, wherein superposing the default wrist accessory on the hand of the user comprises displaying a virtual representation of one of: a default watch design, a default bracelet design, a default tattoo design, or a default wrist brace design.

4. The method of claim 1, wherein determining whether the at least one finger exhibits one of the plurality of pre-defined target finger features comprises:
detecting feature points of fingers of the hand; and
determining whether a number of detected feature points of the hand matches a threshold number of feature points defined in the plurality of pre-defined target finger features.

5. The method of claim 1, wherein the virtual representation of the new wrist accessory is not displayed on the hand when the at least one finger does not exhibit any of the plurality of pre-defined target finger features.

6. The method of claim 1, wherein the virtual representation of the new wrist accessory is displayed when the least one finger exhibits at least one of the pre-defined target finger features.

7. The method of claim 6, wherein selecting the new wrist accessory based on the at least one finger exhibiting one of the pre-defined target finger features comprises selecting a new color or a new texture for the default wrist accessory.

8. A system, comprising:
a memory storing instructions;
a processor coupled to the memory and configured by the instructions to at least:
obtain an image depicting a hand of a user;
superpose a default wrist accessory on the hand of the user;
display the image with the default wrist accessory on the hand of the user;
detect at least one finger on the hand of the user with the default wrist accessory;
determine whether the at least one finger exhibits one of a plurality of pre-defined target finger features;
select a new wrist accessory based on the at least one finger exhibiting one of the pre-defined target finger features; and
display a virtual representation of a new wrist accessory.

9. The system of claim 8, wherein the processor is configured to detect the at least one finger by detecting one or more of: a number of fingers on the hand of the user with the default wrist accessory, a fist formed by the hand of the user, a front of the hand of the user, and a back of the hand of the user.

10. The system of claim 8, wherein the processor is configured to superpose the default wrist accessory on the hand of the user by displaying a virtual representation of one of: a default watch design, a default bracelet design, a default tattoo design, or a default wrist brace design.

11. The system of claim 8, wherein the processor is configured to determine whether the at least one finger exhibits one of the plurality of pre-defined target finger features by:
detecting feature points of fingers of the hand; and
determining whether a number of detected feature points of the hand matches a threshold number of feature points defined in the plurality of pre-defined target finger features.

12. The system of claim 8, wherein the virtual representation of the new wrist accessory is not displayed on the hand when the at least one finger does not exhibit any of the plurality of pre-defined target finger features.

13. The system of claim 8, wherein the virtual representation of the new wrist accessory is displayed when the least one finger exhibits at least one of the pre-defined target finger features.

14. The system of claim 13, wherein the processor is configured to select the new wrist accessory based on the at least one finger exhibiting one of the pre-defined target finger features by selecting a new color or a new texture for the default wrist accessory.

15. A non-transitory computer-readable storage medium storing instructions to be implemented by a computing device having a processor, wherein the instructions, when executed by the processor, cause the computing device to at least:
obtain an image depicting a hand of a user;
superpose a default wrist accessory on the hand of the user;
display the image with the default wrist accessory on the hand of the user;
detect at least one finger on the hand of the user with the default wrist accessory;
determine whether the at least one finger exhibits one of a plurality of pre-defined target finger features;
select a new wrist accessory based on the at least one finger exhibiting one of the pre-defined target finger features; and
display a virtual representation of a new wrist accessory.

16. The non-transitory computer-readable storage medium of claim 15, wherein the processor is configured by the instructions to detect the at least one finger by detecting one or more of: a number of fingers on the hand of the user with the default wrist accessory, a fist formed by the hand of the user, a front of the hand of the user, and a back of the hand of the user.

17. The non-transitory computer-readable storage medium of claim 15, wherein the processor is configured by the instructions to superpose the default wrist accessory on the hand of the user by displaying a virtual representation of one of: a default watch design, a default bracelet design, a default tattoo design, or a default wrist brace design.

18. The non-transitory computer-readable storage medium of claim 15, wherein the processor is configured by the instructions to determine whether the at least one finger exhibits one of the plurality of pre-defined target finger features by:
detecting feature points of fingers of the hand; and
determining whether a number of detected feature points of the hand matches a threshold number of feature points defined in the plurality of pre-defined target finger features.

19. The non-transitory computer-readable storage medium of claim 15, wherein the virtual representation of the new wrist accessory is not displayed on the hand when the at least one finger does not exhibit any of the plurality of pre-defined target finger features.

20. The non-transitory computer-readable storage medium of claim 15, wherein the virtual representation of the new wrist accessory is displayed when the least one finger exhibits at least one of the pre-defined target finger features.
